(19) United States
(12) Patent Application Publication
(10) Pub. No.: US 2014/0205083 A1
(43) Pub. Date: Jul. 24, 2014

(54) SYSTEM FOR APPLYING AND READING OUT AN INFORMATION FIELD IDENTIFYING AND PROTECTING AN OBJECT

(71) Applicants: Evgeniy Ivanovich Pryakhin, St. Petersburg (RU); Ekaterina Vladimirovna Larionova, St. Petersburg (RU); Evgeniy Anatol'evich Zaharenko, St. Petersburg (RU)

(72) Inventors: Evgeniy Ivanovich Pryakhin, St. Petersburg (RU); Ekaterina Vladimirovna Larionova, St. Petersburg (RU); Evgeniy Anatol'evich Zaharenko, St. Petersburg (RU)

(21) Appl. No.: 13/807,633

(22) PCT Filed: Dec. 29, 2011
(86) PCT No.: PCT/RU11/01062

§ 371 Date: Dec. 28, 2012

(51) Int. Cl. H04L 9/08

(52) U.S. Cl. CPC H04L 9/0816
USPC 380/28

(57) ABSTRACT

A hard/software system for applying and reading out an information field identifying and protecting an item, comprises an applying unit, a reading unit, a control unit, and a database unit. The applying unit (for example, a laser or printer) generates the information field and transports it to the item. The control unit comprises an information field data encryption module, a random number generator key, a controlling script configuration module to interact with the applying unit, and a reading and image acquiring module, and a decryption and information output module to interact with the reading unit. The database unit comprises an information field applying unit module, an item material properties module, and an item processing technological mode module for applying the information field. The reading unit can include a digital microscope. The system can apply the information field on various materials, the shape of the item can be plain, cylindrical, etc.

### CROSS-REFERENCE TO RELATED APPLICATIONS

This application is a U.S. continuation-in-part National phase application of the International application PCT/RU2011/001062, filed Dec. 29, 2011, the entire contents of which International application being hereby incorporated into the present application by reference in full.

### BACKGROUND OF THE INVENTION

1. Field of the Invention

The present invention relates to information technologies. More particularly, the invention relates to automated systems for the bit data protection and identification when applied directly onto manufactured products. A hard/software system of the present invention is designed for encoding digital information, converting same into an information field with ultrahigh data writing density to be applied directly onto the product surface, as well as for reading out and recognizing the information written earlier. The claimed system can be used not only to identify various items, but also to protect against counterfeit and ensure the authenticity of various-purpose items, including those designed to be used under extreme environmental conditions (such as high-radioactivity, high temperature, electromagnetic field areas, etc.).

2. Description of the Related Art

With the coming of counterfeit products on the market, the necessity to develop technologies and means ensuring the univocal identification of genuine production emerged. The problem of accounting in production as well as tracking item and part movement becomes nowadays as vital as it was never before. One possible solution of this problem is to encode the necessary information and apply it right onto the surface of a part or an item.

Traditionally, for the purpose of accounting and tracking metal items, they are marked by one of the following methods—an impact, electrochemical, mechanical or painting one. All these methods have a number of disadvantages resulting from their negative effect on the material and a possibility of losing the information or counterfeiting same in case of manufacturing infringing goods. Besides, those methods fail to solve the problem of automated accounting because the machine-readable marking of products immediately in the process of manufacturing is impossible.

It is worth noting that automated accounting is especially important in crucial industries such as metallurgy, machinery, power engineering, automotive-tractor industry, etc.

In addition to the product accounting, the identification task has yet another aspect that at least is equally important. Vendors may face groundless charges resulting from the warranty-based customer return of the goods that in fact were purchased from other companies offering similar products. To protect the product against falsification, the following methods are used: protection elements are implemented that either are hard to reproduce or—when reproduced—entail liability for trade mark forgery or infringing patents protecting product elements.

To protect products, several commonly used methods exist, such as holograms, packing, barcode carrying labels, RFID technology, etc. Used currently for the purpose of the protection and identification has been the DataDot technology for marking the entire range of the car parts with micro-records. Yet, most of the technologies suggest applying the information with various protection levels on intermediate carriers rather than directly on the surface of an item, which seriously compromises the item protection options because, unlike marking the item surface, it does not guarantee the protection element integrity.

Known in the art have been various systems and units for applying and reading the identification data mark on items.

For example, Russian Patent No. 2199781 describes a method of marking a product or an item or a structure with the subsequent identification, and a system for carrying out the identification of a product or an item. The group of inventions relates to the means provided for marking all kinds of products, items or structures, which are industrially manufactured or obtained as a result of other business activity, with the option of verifying their authenticity. The technological result of the inventions is making practically unfeasible to counterfeit, replace or conduct another unauthorized action with regard to the items. The method and the system suggest marking items with the data containing encoded information or a digital signature which the item or a label thereon or another information carrier is provided with, or which are recorded into a memory device the item is intended to be provided with. Authenticity verification is carried out by means of an identification device adapted to convert the abovementioned recorded data into the messages that can be verified with the use of cryptographic algorithms, any interested party being able to review the verification results.

The patent provides that the encoded information containing digital signature is applied onto an additional information carrier to be placed on the item. This feature prevents the technical solution from being used to protect against counterfeit and to guarantee the authenticity of items having to work under extreme environmental conditions such as high-radioactivity, high temperature and electromagnetic field areas, etc.

Also known have been various devices for reading identification marks.

1. Hand-operated contact CCD barcode scanners need either full contact with the barcode surface or should be placed very close to that surface when reading the product marking information, manufacturing companies being Argox, ChampTek, CipherLab, Zebex.

2. A “Light-pen” scanner is a specialized mobile barcode scanner reading barcodes from plain surfaces, the manufacturing company being ZB.

3. Hand-operated laser barcode scanners have the longest operating range and highest speed in reading among all types of scanners and allow reading the information at the range of several dozen centimeters from the item. Laser barcode scanners may be single-beam or multi-beam (multi-plane). Manufacturing companies are Metrologic, Symbol, HHP, Zebex, PSC, Cipher.

4. Unattended (automatic) scanners are used to read both linear and certain bi-dimensional barcode symbols in an automatic mode. Manufacturing companies are Metrologic, Symbol, Cipher, HHP, Zebex.

5. Data accumulating terminals are multifunctional barcode scanners with a built-in memory and a CPU. Such scanners are able to collect and process data read from barcodes. Manufacturing companies are Symbol, Zebex, CipherLab and Casio.

Russian Patent No. 48399 describes a device for the visualization of an optically invisible mark image. This utility model can visualize hidden images (marks) that identify an item and thus protect it against counterfeiting. The device comprises means for cooling down the item to be verified (VI), on a mirrored surface (MS) of which an optically invisible mark image is created through modifying a MS portion by changing the surface energy of the modified MS portion to be able to visualize that optically invisible mark image by creating a water vapor metastable medium in the area of the MS while cooling-down the VI. The visible mark image is obtained as structural differences created by metastable medium particles possessing stable phase at the VI MS portions with different surface energy. The cooling-down means has a slot for placing the VI, and it is designed as a Peltier element implementing the Peltier effect. The device may have optical tools for the visible mark image monitoring.

This technical solution has the following disadvantages:

complicated implementation,

it cannot be used on items made of different materials,

this technical solution cannot be used to protect against counterfeit and to verify the authenticity of items working under extreme environmental conditions (such as high-radioactivity, high temperature and electromagnetic field areas, etc.).

The technical solution disclosed in Russian Patent No. 2281552 is believed to be the closest to the proposed solution as far as the aggregation of essential features is concerned. The patent provides a method of marking and identifying an item and a system for identification the item using the same.

The inventions relate to means for marking items and for implementing effective measures preventing unauthorized production from occurring. The technological outcome is to make it impossible to counterfeit or replace the marked items. The method and system propose marking items with data containing encoded information or a digital signature by providing an item with a memory device or an information carrier containing the abovementioned data, or by applying the data onto the item. The verification of the item authenticity is carried out using an identification device capable of converting the data into messages that can be checked with the use of cryptographic algorithms.

This prior art has the following disadvantages:

1. The key or the identification code is applied to the item beneath a protection layer that can be damaged when in use and this later may disorientate the authenticity verification;

2. The digital signature is applied onto an intermediate carrier. The intermediate carrier can include a chip or a memory device that are susceptible to electromagnetic field and can be totally destroyed thereby, to computer virus attacks, or to hacking;

3. Accounting and monitoring procedure needs additional barcode printing on intermediate carriers;

4. Authenticity verification is carried out either destroying the protective layer or by a connection to a database through a telecommunication network. In the first case, it is impossible to verify authenticity twice (if the equipment needs to be verified after use), whereas in the second case, the information sent over public networks may be intercepted, computer virus infection is possible, or the database may be tampered with;

5. Subject to operation conditions and product designation, not all items can be provided with a memory device or an information carrier;

6. The memory device or barcode information carrier or additional graphical image with identification data are supposed to be placed either on the item or on the label, tag, etc., making it possible to easily replace or remove the identifying components and thus makes it impossible to verify authenticity or read the information about the manufacturer and/or the item.

7. Without access to a telephone line or the Internet, a user cannot verify the item authenticity.

### SUMMARY OF THE INVENTION

The object of the present invention is to develop such a hard/software (H/S) system that would allow applying the information field with ultrahigh data writing density and improved information security directly on an item made of various materials and having various shape; reading and decoding the applied information from the items working under any extreme conditions; saving the decoded information in a digital form, thus enhancing its functionality and item identification reliance.

To achieve the object, a (H/S) system for applying and reading out information fields identifying an item is provided, the system comprising a unit for applying information field, a control unit, a database unit, and an information field reading unit, the system being implemented as follows:

the applying unit is adapted to apply the information field directly on a surface of items made of various materials and having various shapes,

the control unit comprises a program subunit comprising a module for encrypting information field data, with a random-number-generator-based key, a controlling script configuration module for the applying unit, a reading and image acquiring module, a decryption and information output module for the reading unit adapted to correct the decoded information in real time,

the database unit is provided with an information field applying unit database module, an item material properties database module, and a database module with data about item processing modes upon applying the information field thereon,

the reading unit being adapted to visualize the process of reading and to provide a scalable information field image.

The proposed H/S system has following additional features:
the items which the information field is applied onto can be made of metal, polymeric compound, plastics, metal glass, organic glass, wood, ceramics, composites, paper, fabric;
shape of the items to be marked with information field can be planar, cylindrical, circular, hollow, etc.;
to apply information fields onto items made of metals, polymeric compounds, plastics, metal glass, organic glass, wood, ceramics, composites, the devices based upon solid-state, fiber, gas, chemical, and other types of impulse lasers can be used;
to apply the information fields onto items made of paper, organic glass, polymeric compounds, a printer can be used;
to apply the information fields onto items made of metal, metallic glass, polymeric compounds, plastics, the devices based on mechanical dot peening can be used;
optical tools capable of capturing and scaling images from various surfaces and adapted to be connected to the control unit or self-inclusive, and—more specifically—a mobile digital optical microscope can be used as the reading unit;
the information field can include a company logo or another image, e.g. a color one, or a standard barcode, or a nano-formatted matrix barcode (nano barcode), etc.

The proposed H/S is capable of (a) creating unique nano-scale information fields with ultrahigh data writing density; (b) applying nano-scale information fields with ultrahigh data writing density directly on item using laser and other technologies; (c) reading and decoding the nano-scale information fields with ultrahigh data writing density; (d) saving the decoded information in digital form; (e) identifying various-purpose parts and items; (f) carrying out inventory auditing, property evaluation and other operations; (g) providing improved item authenticity protection; (h) evaluating broken part based upon the data recorded into a reference specification information field.

Nano-scale information fields with ultrahigh information writing density and enhanced protection have the following particular advantages:
a surface to be marked needs no preparation prior to marking;
large amount of information can be written;
information can be preserved during the entire life cycle of the part (item), allowing the part identification in an emergency as well;
parts with those fields can work under extreme environmental conditions (high temperature, high pressure, aggressive environment, radiation and electromagnetic fields, etc.);
the fields are not affected by EMI and radio interference;
the barcode can be read out using conventional equipment;
they can work under extreme climatic and harmful environmental conditions;
they provide high-degree information protection;
they are highly resistant to viruses;
they make it more difficult to forge information for making counterfeit products.

Depending on requirements, the proposed information field may comprise a manufacturing company logo in color and/or a standard barcode that can be unidimensional or planar, and/or nano-scale matrix barcode (nano barcode) created directly on a surface of a part or an item.

Company Logo.

A laser beam creates oxide structures less than 100 nm thick on a surface of metal. Depending on the laser processing technological mode and on the chemical composition of the material, these structures expose various color shades, thus making it possible to create a color image, particularly a company logo, on the surface of the metal without using additional colorants.

The amount of the colors depends on the material chemical composition: some materials, such as stainless steel, allow up to 100 and more colors, whereas the others, like aluminum, offer only certain shades of black. Thus, the system of the present invention allows to reproduce precisely a company logo both as a color image and as a hologram.

The time of formation of the color image depends on its dimensions and on the amount of shades the image contains.

Barcode.

The use of laser technologies offers applying the barcode directly on a part/item, complying with standard color combinations for the background and barcode itself to ensure the reliable information read-out by conventional scanners.

Nano-Scale Matrix Barcode (Nano-Bar Code).

The text information encoding system used to create information fields provides for changing the code more than 10⁷⁰⁶ times. Recognition or falsification of such information having no individual code table is practically impossible.

High density of writing the encoded information allows creating the information fields on the item surface that contain any text information: chemical composition and mechanical properties of the item material, a detailed description of the manufacturing process of the item, etc. The area of 1.5×10 mm may contain 1962 text characters (that is a little more than one standard typewritten page), while the area of 20×25 mm may contain five standard typewritten pages of text. Outputting a single standard typewritten text page takes less than 30 seconds.

The information field is created by laser immediately on the surface of an item in a nano-cluster form of the item prime material. Thus the information field can be used on the parts operating at elevated temperature and pressure, high radiation zones and areas with electromagnetic fields, as well as under other extreme environmental conditions that are destructive for other types of marks.

### BRIEF DESCRIPTION OF THE DRAWINGS

All these and other objects, features, and advantages of the present invention will be better understood from the ensuing description accompanied by the following drawings, in which

FIG. 1 shows a block diagram of the proposed H/S system;

FIGS. 2A-2B show the H/S system operation algorithm;

FIG. 3 shows an embodiment of the applying unit including a solid-state impulse laser;

FIG. 4 shows the block diagram of the automated control system (ACS) managing the parameters and the technological process of the applying unit including the solid-state impulse laser.

### DETAILED DESCRIPTION OF THE INVENTION

The hard/software system 100 for forming and reading out information fields with ultrahigh information writing density and enhanced protection according to the present invention is designed using modular architecture and comprises the following units, subunits, and modules: an applying unit 1; a reading unit 2; a control unit 3 with a program subunit 4 that comprises an information encryption module 5, a control script configuration module 6 for the applying unit 1, an image reading and acquiring module 7, and a module 8 for decrypting and outputting information for the reading unit 2; a database unit 9 comprising an information field applying unit database module 10, an item material property database module 11, and an item processing mode database module 12. The module 11 stores information about physical, chemical, and mechanical properties of the material needed for designing processing modes and compiling the processing mode database for the module 12. The module 12 comprises information about processing mode technological data needed for arriving at a predetermined result when materials from the module 11 database are processed. Having the modules is believed to be essential since they contribute to reliability of the whole system when dealing with various items to be marked. The control unit 3 can include a personal computer.

The H/S system solves the work process automation task by executing a number of the automated procedures such as automation of processing any digital information with encoding the same based upon the item material, laser unit parameters, and input parameters; automation of forming the laser unit control script; automation of processing the image obtained by the reading unit; automation of decoding graphical elements; automation of forming information fields.

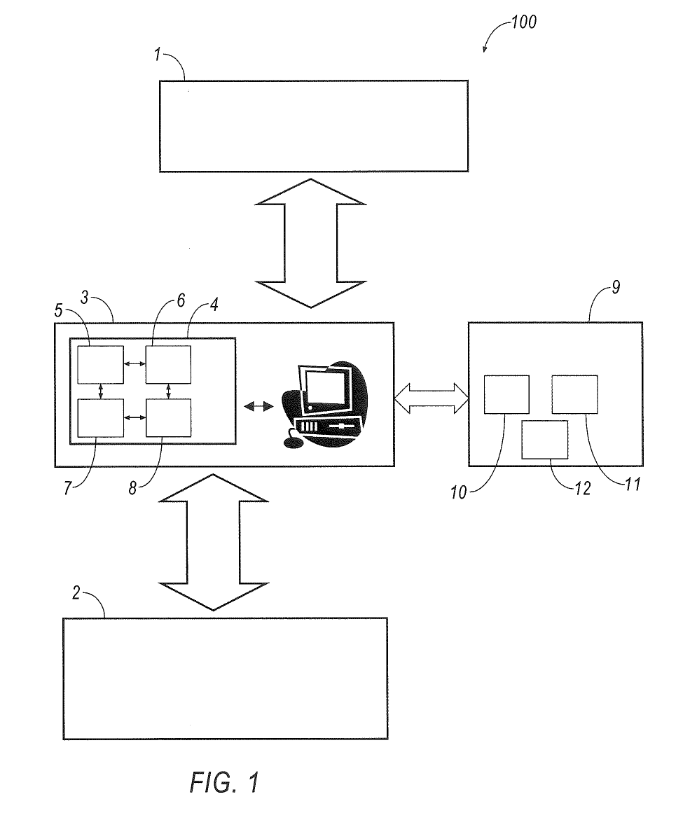

The proposed H/S system operates, with reference to FIGS. 1-4, as follows. It is to be understood that button 38 “Start” initiates the operation of the applying unit 1. (By the same token, green lamp 39 is an indicator of normal operation of the applying unit 1; button 40 “Stop” serves for emergency deactivation of the unit; “Radiation” lamp 41 is an active radiation indicator; red lamp 42 is a no-radiation indicator; and a cut-off plate 43, including a hinged key, unblocks radiation to bring the applying unit 1 into the operational mode). The button 38 “Start” does not work unless the cut-off plate 43 is activated.

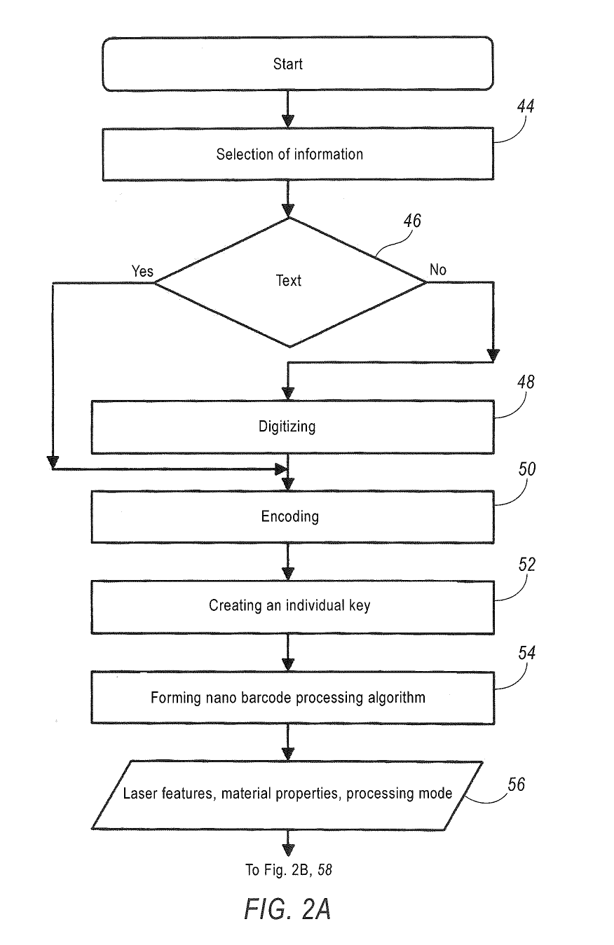

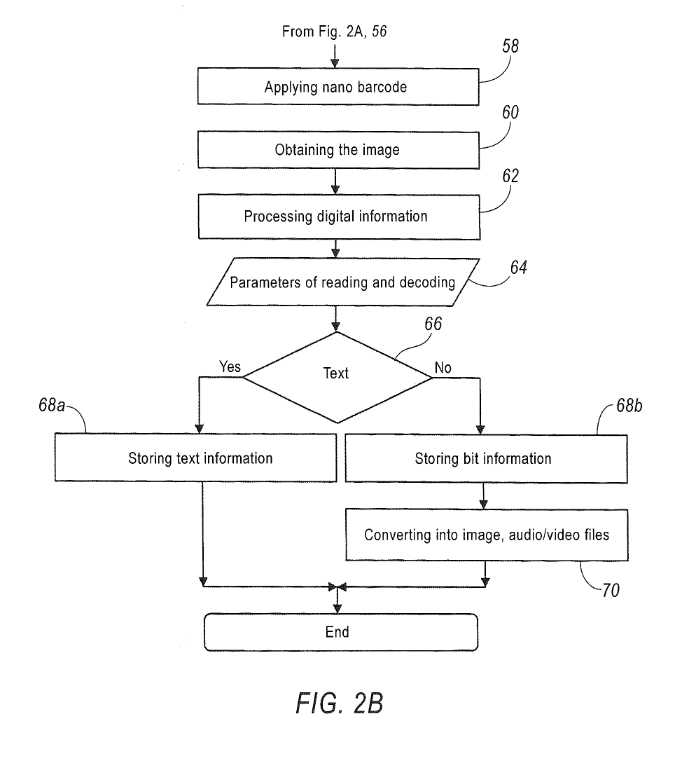

A user selects information to be encoded and encrypted (step 44, FIG. 2). If the information is a text, downloading the text into an encoding program, and processing same therein, is performed (step 50). If the information is an executable file, image, or audio/video file, it is digitized (step 48). In this way, information in a selected form of text, image, executable file, audio-, video-file, etc., already in a digital form or digitized, is processed by the encoding program (in the information encryption module 5, step 50) by an algorithm shown in FIG. 2 providing creating an individual key with the use of a random number generator (not shown) (step 52). The random number generator protects the encoded information, in fact eliminating the possibility of uncovering individual key. In an automatic mode, the encoding program creates (step 54) an algorithm for processing nano-barcode (in the controlling script configuration module 6 for the applying unit 1) for the laser unit or another unit of applying information based upon the input data that takes into account (step 56):
class and technological features of the laser or another applying unit (the data comes from the module 10),
properties of the material which a new generation barcode is supposed to be applied on (the data comes from the module 11),
technological modes of processing the material (the data comes from the module 12).

According to the generated script, the applying unit 1, controlled by the control unit performs nano formatting (step 58) of the surface or sub-surface layer of the item thus creating an identification mark (an information field) directly on the item. Nano formatting of the subsurface layer takes place where the surface layer is a transparent one. For example, lacquer coating can be transparent for a solid-state laser, in which case the identification mark will be created under the lacquer coating.

Upon identification, when there is a necessity to read the mark, the image of the mark obtained with the use of the reading unit 2 (step 60) is downloaded as an image into a specialized image decoding and processing program (in the reading and image acquiring module 7, step 62)). Decoding, decryption, and storing the bit information is carried out with consideration for reading and decoding parameters (in the decryption and information output module 8).

The decoding process is carried out visualized to thus provide the feedback allowing information decoding correction in real time. This feature can be realized by the use of a microscope/camera, or similar devices, in the reading unit 2.

The decoded information is saved as a separate file to be converted back into the initial text, image, executable file, audio-, video-file, etc., the program allowing saving the decoded information as a separate text document.

The operation of the reading unit 2 is based upon acquiring an analogue image to be then converted into a digital form for further processing and is illustrated by steps 60-70 in FIG. 2.

The image of the information field is downloaded into the decryption module 8. For every bit of information, a cell in a spatial scalable coordinate grid is automatically created. Color confidence intervals for white and black are established to determine essential and subsidiary elements of the identification mark. At the last stage, when a large amount of information is processed, non-decrypted information fragments, symbols or bits are pinpointed manually if necessary. Additional setup routines in the program are provided for those non-decrypted fragments to specify decoding and decryption parameters. Such a mode is called semi-automatic, because the information decryption process still needs user's supervision.

The applying unit 1 may, for example, include an industrial laser processing unit with minor changes and supplements, for example with additional feedback sensors such as those used in conventional laser cutting units.

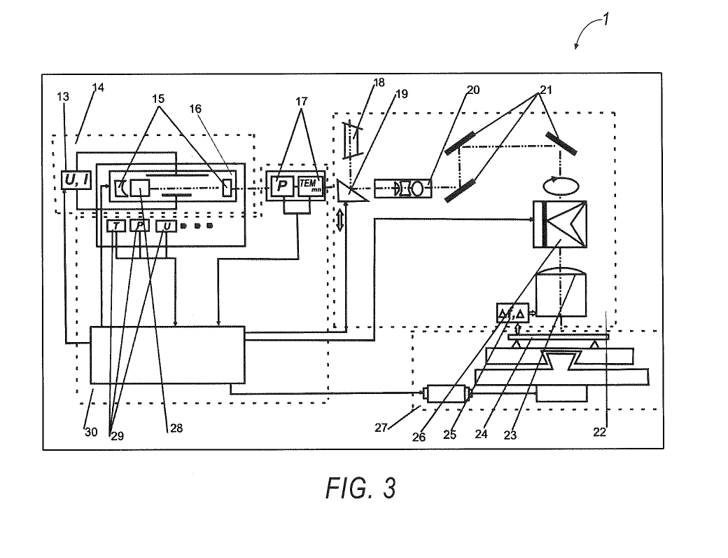

FIG. 3 shows a block diagram of such a laser processing unit. It comprises a laser emitter 14, the radiation forming and transportation system 22, a coordinate unit 27, and an the automated control system (ACS) 30.

The laser emitter 14 generates a laser beam with optical, power, spatial and temporal parameters necessary for cutting. The block contains a laser pumping system 13; an active laser substance 16; resonator mirrors 15, and, whenever necessary, a radiation modulation unit 28.

Usually, the laser emitter includes a solid-state laser (such as a fiber laser) capable to work both in continuous and in impulse mode.

The system 22 of radiation forming and transportation serves for the laser beam delivery from the laser emitter to the processed area. This system can comprise an alignment laser 18; an optical gate 19; optical transformers (lenses) 20; hinged mirrors 21; a polarization plane rotation unit 26; a focusing system 23; a focal plane and clearance stabilization system 25.

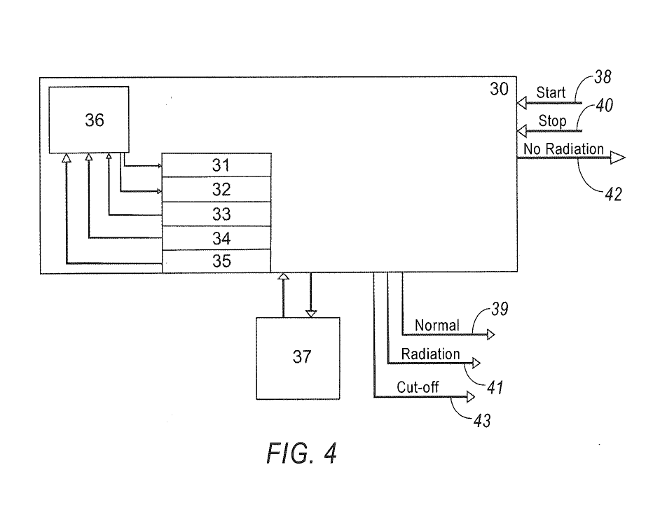

The ACS 30, shown in more detail in FIG. 4, also comprises a subunit 31 of the laser parameter sensors (temperature, pressure, working mixture, etc.); subunit 32 comprising laser beam parameter sensors (divergence, power, direction diagram axis stability, etc.); a laser beam lockout device 33; an active irradiation switch 34; a current control device 35 allowing changing the irradiation parameters without using a computer; a cooling-down device 36; and a computer 37. The ACS 30 serves for controlling laser beam parameters and for transferring commands to actuating modules of the coordinate unit 27. The coordinate unit 27 may have no actuating modules and comprise a three-way table with a servo unit instead, or just an item stopper with clamps. The cut-off plate 43 can be a part of the ACS 30.

The abovementioned components are installed into the applying unit 1 according to conventional scheme assemblies.

Additionally included in the unit 1 are a laser beam output parameter metering system 17, a focal plane and clearance stabilization system 25, and laser parameter sensors 29. Dashed boxes shown in FIG. 3 with no designation thereof illustrate an example of scheme assemblies collectively making the applying unit 1.

Having the feedback laser parameter subsystem 31 in the ACS 30 allows monitoring the beam parameters in real time, controlling the process of forming the information field thus improving the precision of applying the same.

To have a wider range of items suitable for applying the information field thereon, as well as to improve precision, the beam energy in the laser processing unit 1 can be delivered to the target area as follows. During the laser processing, an item can either move linearly in a plane that is perpendicular to the focused beam axis or rotate around this axis. To turn the laser beam through the necessary angle, a mirror, or a system of mirrors, or a system of prisms is placed between the laser emitter and lens. The laser emitter with the lens can move relative to the standing item, or the laser emitter and the item can move simultaneously. To dispense with moving the laser emitter and the item in the laser processing, the laser radiation can be delivered to the marking area by a system comprising mirrors/prisms and the lens rotating around the beam axis or around the item when it is being processed (marked).

The mirrors and lens can move linearly or rotate around the laser emitter axis and move backwards perpendicular to the laser emitter axis. When the marking area is small enough, two-dimensional motion of the laser beam can be carried out by rotating the mirrors around two mutually perpendicular axes. To rotate and focus the laser beam, a single spherical mirror only can be used.

Laser beam can also reach the marking area using a gimbaled mirror turning relative to two mutually perpendicular axes. Turning the mirror allows marking the item about a predetermined contour line. While marking the inner space of a cylindrical item, the mirror with the lens simultaneously move along, and rotate around, the laser beam axis. To mark lightweight long pipes or materials supplied in rolls (for example, metal foil), the mirror, lens, and item move simultaneously, the item either rotating about the axis normal to the laser beam axis or moving linearly and normal to the beam axis. The system also comprises an optical system including the focusing system 23 to track the lens location relative to the item.

The use of the laser is not the only example of how the applying unit 1 can be made. It can alternatively include a printer such as Samsung SCX 4200, if the item to be marked is of paper or other material a printer can create a mark on.

The reading unit 2 can be built based on the principles of operation of a digital microscope and digital devices capable of capturing and processing photo and video images and can comprise two modules (not shown): an optical module responsible for magnifying images invisible to the unaided eye and a digital module responsible for capturing an analogue image and converting the same into a digital form. It can comprise, for example: CMOS sensor (CMOS matrix), analog-to-digital converter, signal amplifier, processor, and memory element.

Having reached the CMOS sensor cells, the image finds its way to field transistors in the cells that change the state under light either blocking the electric current or—vice versa—amplifying the signal. The camera electronic circuit reads out the CMOS sensor cell state changes and builds the image based on that.

The CMOS sensors are made as a large hybrid chip with camera service circuits, analog-to-digital converter (ADC), electronic shutter (instant CMOS sensor state data reading circuit), and white balance and image compression circuits mounted thereon. To improve the precision of operation of the matrix (to obtain a better signal to noise ratio) and luminous sensitivity, each CMOS sensor cell is provided with converging micro lenses focusing the light flux. After it has been focused by the lenses, the is split by a dedicated prism into three identical light fluxes, each exposing its own matrix through one of the filters of the basic colors—red, green and blue. The creation of the image takes place after the analogue signal from the camera CMOS sensor cells has been converted into the digital form by the ADC. All the exposed CMOS cells participate in the color image creation. In image processing, complicated interpolation methods are used. Particularly, color components of each neighbor pixel are taken into consideration. As a result of processing by a built-in processor, a realistic image is generated that corresponds to the actual image to the fullest extent.

It is to be understood that the embodiments described in this specification are given by example only and not in a limiting sense. Those skilled in the art may make various modifications and additions to the embodiments chosen to illustrate the invention without departing from the spirit and scope of the present contribution to the art. For example, any optical or digital apparatus capable of obtaining an image whose quality is sufficient for decrypting and decoding the same can be used for capturing the image and transmitting the same to the control unit (computer), the quality being defined visually, i.e. discrete prints should be distinguishable. A Canon camera with an additional high-magnification/high resolution objective can be used, as well as digital microscope JJ-Optics Digital Lab Mobile USB or Forever Plus FPC-M500 5 megapixel USB microscope. Accordingly, it is to be realized that the patent protection sought and to be afforded hereby shall be deemed to extend to the subject matter claimed and all equivalents thereof fairly within the scope of the invention.

1-9. (canceled)

10. A hard/software system for applying and reading out an information field identifying and protecting an item, comprising:
an applying unit,
a reading unit,
a control unit, and
a database unit,
the applying unit comprising means for generating the information field and transporting same to the item,
the control unit comprising an information field data encryption module, a random number generator key, a controlling script configuration module to interact with the applying unit, and a reading and image acquiring module, and a decryption and information output module to interact with the reading unit, and
the database unit comprising an information field applying unit module, an item material properties module, and an item processing technological mode module for applying the information field.

11. The hard/software system as claimed in claim 10, wherein the materials for applying the information field can be metals, polymeric compounds, plastics, metal glass, organic glass, wood, ceramics, compound materials, paper, fabrics.

12. The hard/software system as claimed in claim 10, wherein the shape of items where the information field is to be applied can be plain, cylindrical, circular, hollow, etc.

13. The hard/software system as claimed in claim 10, wherein the generating means includes an impulse laser.

14. The hard/software system as claimed in claim 10, wherein the generating means includes a printer.

15. The hard/software system as claimed in claim 10, wherein the generating means includes a device based upon mechanical dot pressure upon material.

16. The hard/software system as claimed in claim 10, wherein the reading unit includes a digital microscope.
